(19) United States
(12) Patent Application Publication
(10) Pub. No.: US 2021/0394207 A1
(43) Pub. Date: Dec. 23, 2021

(54) SPRAYER APPARATUS WITH REMOVABLE SOLUTION CONTAINER

(71) Applicant: Aseptic Health, LLC, Nashiville, TN (US)

(72) Inventors: Autumn Ryan, Nashville, TN (US); Dana Ryan, Mt. Juliet, TN (US); Stephen Lawson, Ballwin, MO (US)

(21) Appl. No.: 17/352,200

(22) Filed: Jun. 18, 2021

Related U.S. Application Data
(60) Provisional application No. 63/041,093, filed on Jun. 18, 2020.

(51) Int. Cl. B05B 5/16; B05B 9/04; B05B 5/025

(52) U.S. Cl. CPC B05B 5/1691; B05B 5/025; B05B 9/0426

(57) ABSTRACT

A sprayer device includes a pump having a pump inlet and a pump outlet, the pump inlet including a first quick connector, a spray nozzle fluidly communicated with the pump outlet, and a sealed solution container including a second quick connector, the second quick connector removably connectable to the first quick connector of the pump inlet to fluidly communicate the solution container with the pump inlet. The pump can be positioned within a pump housing and the sealed solution container can be positioned within a container support structure. The pump housing and container support structure may further be contained within a backpack carrier. The spray nozzle may comprise an electrostatic or turbulent flow spray device, amongst other things.

### CROSS-REFERENCES TO RELATED APPLICATIONS

This application claims the benefit of U.S. Provisional Application No. 63/041,093 filed on Jun. 18, 2020 and entitled “Sprayer Apparatus With Removable Solution Container,” which is incorporated by reference herein in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to sprayer devices such as handheld sprayer devices or backpack sprayer devices. Such devices can include a pump connected to a sprayer nozzle. The pump can pump a solution to the sprayer nozzle where it can be forced out of the sprayer nozzle and dispersed across a desired target area. Such sprayers can be used to spray chemicals such as insecticides, disinfectants, weed or bug killers, fertilizers, etc.

Conventional sprayers can include a built in solution container or reservoir wherein liquids to be dispersed by the sprayer can be poured. The pump can draw liquid from the built in reservoir or container and pump the liquid to the spray nozzle. Such built in containers can be cumbersome to refill between uses, as liquids have to be manually poured into the reservoirs.

Another problem with such built in reservoirs is that in many applications, chemical solutions and/or dilutions must be mixed by the user and poured into the retainer or mixed directly in the container. The manual mixing of spray solution on site can often lead to error in the concentrations of the active ingredients recommended for a particular situation. This can lead to the chemical spray solution not being effective or working as intended when a solution is over diluted or too weak, or the chemical spray solution can be potentially dangerous to the user and/or the target area of the solution is not diluted enough or is too strong.

What is needed then are improvements to sprayer devices.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure is a sprayer device including a pump having a pump inlet and a pump outlet, the pump inlet including a first quick connector. A spray nozzle can be fluidly communicated with the pump outlet. A sealed solution container can including a second quick connector, the second quick connector removably connectable to the first quick connector of the pump inlet to fluidly communicate the solution container with the pump inlet.

Another aspect of the present disclosure is a method of spraying a solution comprising the steps of: providing a sprayer device including a pump having a pump inlet and a pump outlet, the pump inlet including a first quick connector and a spray nozzle fluidly communicated with the pump outlet; providing a sealed solution container prefilled with the solution, the sealed solution container including a second quick connector; removably connecting the first quick connector to the second quick connector to fluidly communicate the sealed solution container with the pump inlet; and pumping the solution via the pump from the sealed solution container to the spray nozzle.

The method can further include the steps of: disconnecting the first and second quick connectors from one another; providing a second sealed solution container prefilled with a second solution, the second sealed solution container including a third quick connector; connecting the first and third quick connectors to fluidly couple the second sealed solution container to the pump inlet; and pumping the second solution via the pump from the second sealed solution container to the spray nozzle.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a rear view of one exemplary embodiment of a sprayer device of the present disclosure.

FIG. 2 is a schematic view of another exemplary embodiment of a sprayer device wherein a pump and sealed solution container are each integrated and retained within a backpack carrier.

FIG. 3 is an isometric view of the sprayer device of FIG. 1.

FIG. 4 is an exploded view of one embodiment of a sealed solution container and a container support structure of the present disclosure.

FIG. 5 is a side view of one embodiment of a spray nozzle.

FIGS. 6A and 6B illustrate different embodiments of a sealed solution container of the present disclosure.

FIG. 7A is a partial cross sectional view of one embodiment of first and second quick connectors in coupled to one another to allow fluid to flow between the first and second quick connectors.

FIG. 7B is a partial cross sectional view of one embodiment of first and second quick connectors in uncoupled from one another to allow to prevent fluid flow between the first and second quick connectors.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

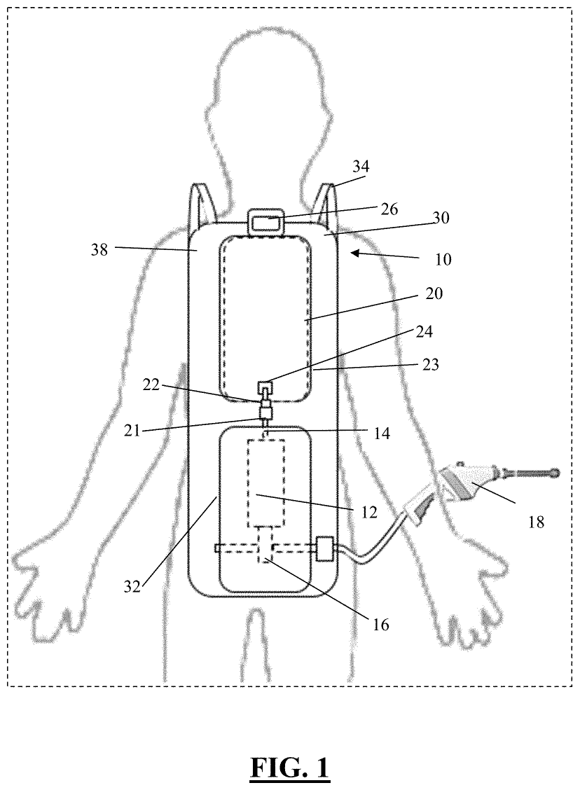

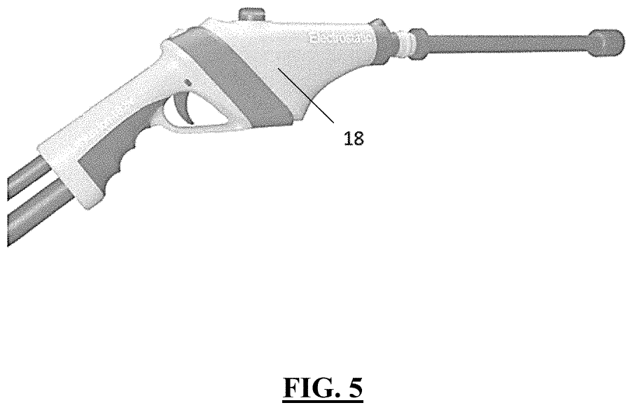

Referring now to the drawings, FIG. 1 illustrates an embodiment of a sprayer device 10 of the present disclosure. The sprayer device 10 can include a pump 12 having a pump inlet 14 and a pump outlet 16, the pump inlet 14 including a first quick connector 21. A spray nozzle 18 can be fluidly communicated with the pump outlet 16. The spray nozzle 18 can be a pressurized spray nozzle and can be fitted with different tips with varying size orifices to create different spray profiles. In some embodiments, such as that seen in FIG. 5, the spray nozzle 18 can be an electrostatic spray device, while in other embodiments, the spray nozzle 18 may be a turbulent flow spray device that can be designed to spray a mist or fog of atomized spray. A sealed solution container 20 can including a second quick connector 22, the second quick connector 22 removably connectable to the first quick connector 21 of the pump inlet 14 to fluidly communicate the solution container 20 with the pump inlet 14. In some embodiments, any or all of the components discussed herein can be fluidly connected, communicated, or coupled to one another via suitable hosing.

Having quick connectors 21 and 22 on the pump inlet 14 and the sealed solution container 20 respectively can allow different sealed solution containers 20 to be readily interchangeable on the sprayer device 10. This can allow manufacturers of different chemical products or solutions to sell the sealed solution containers 20 separately from the spray device 10, the sealed solution container 20 being prefilled with a desired chemical solution at a desired concentration. The user can identify what chemical and concentration is needed for a particular use, select the corresponding sealed solution container 20, quickly connect the sealed solution container 20 to the pump inlet 14 via the quick connectors 21 and 22, and start spraying.

Providing a sealed solution container 20 that can be readily connected to the pump 12 on a sprayer can help reduce the time it takes to refill solution to be used for the sprayer by manual filling methods. It can also help reduce any operator error in providing a correct concentration for a desired chemical, as the manufacturer who will typically have better measurement equipment can produce the chemical in a desired concentration and prefill the sealed solution container 20 with the properly measured solution.

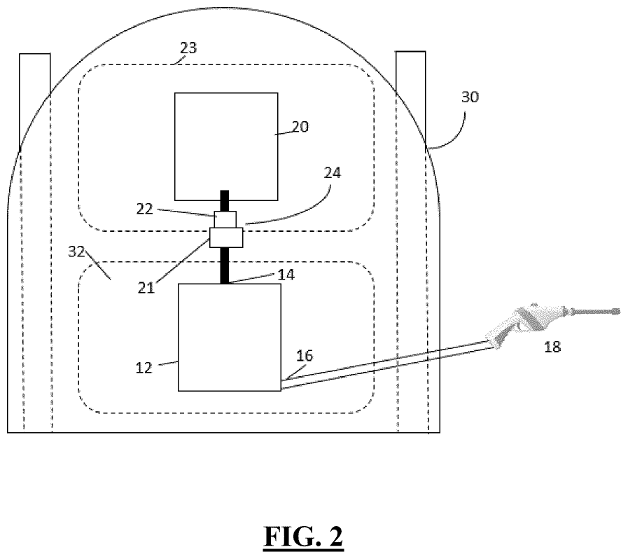

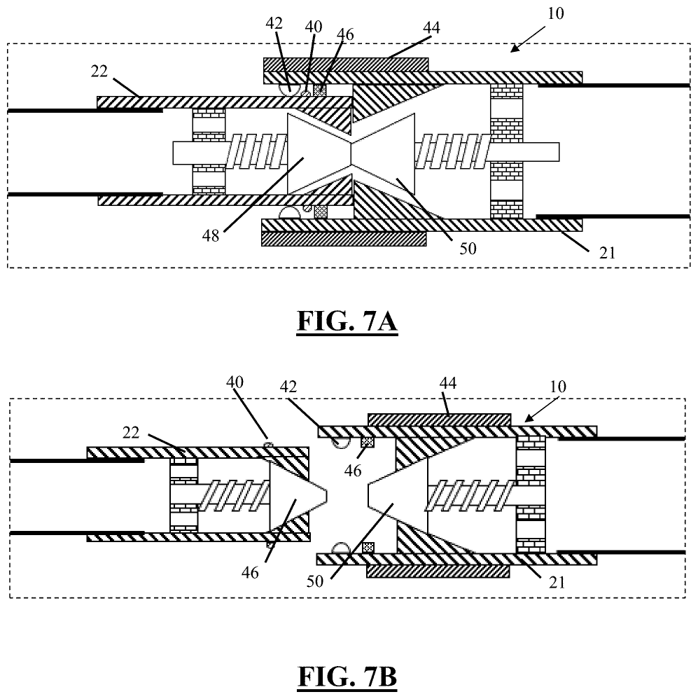

The quick connectors 21 and 22, as depicted more clearly in FIG. 2, can be any suitable connectors which can be readily connected and disconnected from one another to fluidly communicate the sealed solution container 20 and the pump inlet 14. In some embodiments, as shown in FIGS. 7A and 7B, the quick connectors 21 and 22 can include a male connector 22 with a retention member 40 or groove defined on the male connector 22 that can receive bearings 42 or other protrusions extending radially inward from the female connector 21 to retain the connection between the two connectors 21 and 22. The female quick connector 21 can include a slider 44 that can be moved to retract the bearings 42 or allow the bearings 42 to be retracted within the female quick connector 21 so that the connectors 21 and 22 can be released. In some embodiments the female connector 22 can include a gasket 46 that can be compressed by the male quick connector 21 when the two quick connectors 21 and 22 are coupled or connected to one another to create a watertight seal between the two connectors 21 and 22.

In other embodiments, the quick connectors 21 and 22 can any suitable type of quick connect assembly for sealingly securing two fluid lines together, including but not limited to, twist lock type connectors, threaded connectors, connectors with cam clamps, etc. The quick connectors can include gaskets or other sealing members for creating a watertight seal between the first and second quick connectors 21 and 22 when the first and second quick connectors 21 and 22 are connected together, thus helping prevent leakage of the solution from the first and second quick connectors 21 and 22

Referring now to FIGS. 1 and 7A-7B, in some embodiments, the second quick connector 22 coupled to the sealed solution container 20 can include a valve 48 which can be selectively opened to release solution from the sealed solution container 20. In some embodiments, the valve 48 can be biased in a closed position, such as in a mechanical spring valve, when the first and second quick connectors 21 and 22 are not connect to one another, and the valve 48 can be moved to an open position when the first and second quick connectors 21 and 22 are connected to one another. Having a valve on the second quick connector 22 coupled to the sealed solution container 20 can allow an empty sealed solution container to be filled or refilled prior to connection to the pump inlet 14. As such, empty sealed solution containers can be shipped to chemical manufacturers and filled onsite via the second quick connector 22 prior to the sale of sealed solution container 20 to the end customer. Once purchased the sealed solution container 20 can be quickly and conveniently connected to the pump inlet 14 by the customer via the second quick connector 22.

In some embodiments, as shown in FIGS. 7A and 7B, the first quick connector 21 can also have a first quick connector valve 50. The first and second quick connector valves 48 and 50 can engage one another when the first and second quick connectors 21 and 22 are coupled together to move both the first and second quick connector valves 48 and 50 to an open position to allow for fluid flow between the first and second quick connectors 21 and 22. When the first and second quick connectors 21 and 22 are disconnected from one another, both the first and second quick connector valves 48 and 50 can be returned to a closed position to help prevent leakage of solution or fluid from the sealed solution container 20 and the pump inlet 14.

In other embodiments, the second quick connector 22 can include a manual switch valve, such as a stop cock valve, which can be manually moved from a closed position to an open position once the quick connectors 21 and 22 are connected to one another.

In some embodiments, the second quick connector 22 can be a male connector and the first quick connector 21 can be a female connector. Female connectors to be more expensive to manufacture than their male counterparts. It can be beneficial to have the male connector coupled to the sealed solution container 20, which in some applications is designed to be disposable, such that the less expensive connector is being disposed of and replaced between uses of different sealed solution containers 20.

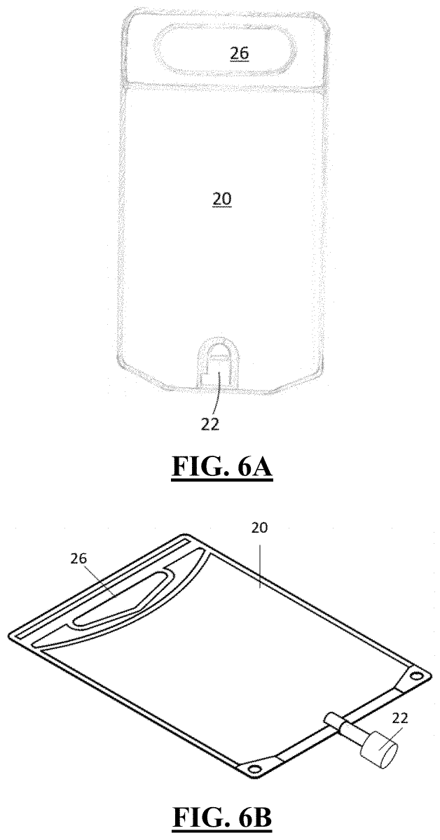

In some embodiments, such as those shown in FIGS. 6A and 6B, the sealed solution container 20 can be a hermitically sealed bag manufactured by RF welding two pieces of plastic or other flexible material together along their perimeters to produce a hermetic seal around the sealed solution container 20. The second quick connector 22 can be bonded around an opening in the sealed solution container 20, such that a seal can be formed between the sealed solution container 20 or bag and the second quick connector 22. In other embodiments, the sealed solution container 20 can be made of a rigid plastic material with a second quick connector 22 mounted or bonded to the rigid plastic material of the sealed solution container 20.

As illustrated in FIGS. 1-4, in some embodiments, the sprayer device 10 can further include a backpack carrier 30, wherein the pump 12 and the sealed solution container 20 can be retainable on or inside of the backpack carrier 30. In some embodiments, as shown in FIG. 1, the backpack carrier 30 can include a frame or mounting structure 38 on which the pump 12 and the sealed solution container 20 can be retained. In other embodiments, as shown in FIG. 2, the backpack carrier 30 can comprise a more traditional style backpack, similar to the type worn by students to school, with an internal pocket inside of which the pump 12 and sealed solution container 20 can be contained and/or affixed.

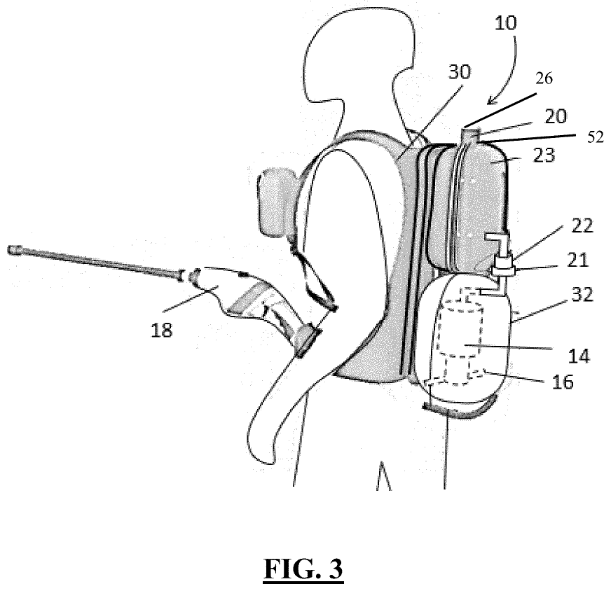

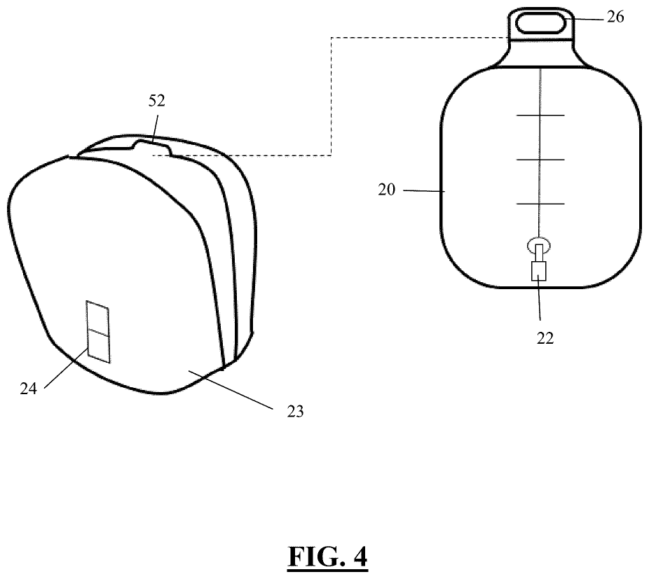

In some embodiments, the sprayer device 10 can include a pump housing 32, the pump 12 positioned within the pump housing 32, and a container support structure 23, the sealed solution container 20 removably positionable on or inside of the container support structure 23. The pump housing 32 can help protect the pump 12 during use of the sprayer device 10. The container support structure 23 can help maintain the sealed solution container 20 in a desired orientation to allow for more efficient fluid flow, for instance in a generally vertical orientation with the second quick connector 22 generally at the bottom of the sealed solution container 20, when the sealed solution container 20 is on or in the backpack carrier 20. In some embodiments, as shown in FIGS. 3 and 4, the container support structure 23 can be an hard shell which can be opened such that the sealed solution container 20 can be placed within and subsequently removed from the hard shell container support structure 23. The backpack carrier 30 can include shoulder straps 34 allowing the sprayer device 10 to be carried on a user's back. In still other embodiments, the sprayer device can be a hand held or carrier spray with a frame which can be carried in the hands of the user, the pump mounted to the frame and the sealed solution container retainable on the frame.

In some embodiments, like the one seen in FIG. 1, the pump inlet 14 and pump outlet 16 can extend through the pump housing 32; and the container support structure 23 can include a quick connector access opening 24, wherein the second quick connector 22 on the sealed solution container 20 is accessible through the quick connector access opening 24 when the sealed solution container 20 is positioned on or in the container support structure 23. As such, the sealed solution container 20 can be placed on or within the container support structure 23 and the second quick connector 22 can be readily accessible for connection to the first quick connector 21. In some embodiments, the container support structure 23 can be made from a rigid material such as plastic, which can help protect the sealed solution container 20 from being damaged during use. For instance, when the container 20 is a bag, the container support structure 23 can help protect the bag 20 from puncture from other tools, tree branches, etc. that may come into contact with the sprayer device 10 during use.

In some embodiments, like those of FIGS. 6A and 6B, the sealed solution container 20 can include a handle 26 for carrying the sealed solution container 20. In some embodiments, the handle 26 can be integrally formed into the sealed solution container 20 or part of the bag itself. In other embodiments, the handle 26 can be a separate piece of material, such as plastic, which can be attached to the sealed solution container 20. As shown in FIGS. 3-4, the container support structure 23 in some embodiments can include a handle aperture 52, wherein the handle 26 of the sealed solution container 20 can extend through the handle aperture 52 in the container support structurer 23. As such, the user can carry the entire sprayer device 10 via the handle 26 on the sealed solution container 20 when the container 20 is positioned within the container support structure 23.

Another aspect of the present disclosure is a method of spraying a solution comprising the steps of: providing a sprayer device 10 including a pump 12 having a pump inlet 14 and a pump outlet 16, the pump inlet 14 including a first quick connector 21 and a spray nozzle 18 fluidly communicated with the pump outlet 16; providing a sealed solution container 20 prefilled with the solution, the sealed solution container 20 including a second quick connector 22; removably connecting the first quick connector 21 to the second quick connector 22 to fluidly communicate the sealed solution container 20 with the pump inlet 14; and pumping the solution via the pump 12 from the sealed solution container 20 to the spray nozzle 18.

The method can further include the steps of: positioning the pump 12 inside of a pump housing 32; and positioning the sealed solution container 20 inside of a container support structure 23; wherein the pump housing 32 and the container support structure 23 are both located on or inside of a backpack carrier.

The method can further include the steps of: disconnecting the first and second quick connectors from one another; providing a second sealed solution container prefilled with a second solution, the second sealed solution container including a third quick connector; connecting the first and third quick connectors to fluidly couple the second sealed solution container to the pump inlet; and pumping the second solution via the pump from the second sealed solution container to the spray nozzle. Although the steps for the various methods of spraying a solution have been listed in a particular order in the foregoing disclosure, it is not intended that such particular order be construed as limitations upon the order in which such steps must be taken.

Thus, although there have been described particular embodiments of the present invention of a new and useful SPRAYER APPARATUS WITH REMOVABLE SOLUTION CONTAINER, it is not intended that such references be construed as limitations upon the scope of this invention.

What is claimed is:

1. A sprayer device comprising:
a pump having a pump inlet and a pump outlet, the pump inlet including a first quick connector;
a spray nozzle fluidly communicated with the pump outlet; and
a sealed solution container including a second quick connector, the second quick connector removably connectable to the first quick connector of the pump inlet to fluidly communicate the solution container with the pump inlet.

2. The device of claim 1, wherein the second quick connector includes a valve which is biased in a closed position when the first and second quick connectors are not connect to one another, and the valve is moved to an open position when the first and second quick connectors are connected to one another.

3. The device of claim 2, wherein the pump and sealed solution container are housed within a backpack carrier.

4. The device of claim 3, further comprising:
a pump housing located inside of the backpack carrier; and
a container support structure located inside of the backpack carrier;
wherein the pump is positioned within the pump housing and the sealed solution container is removably positionable on the container support structure.

5. The device of claim 4, wherein:
the pump inlet and pump outlet extend through the pump housing; and
the container support structure includes a quick connector access opening, wherein the second quick connector on the sealed solution container is accessible through the quick connector access opening when the sealed solution container is positioned on the container support structure.

6. The device of claim 5, wherein the sealed solution container is a hermitically sealed bag that includes a carrying handle, and wherein the second quick connector is bonded to the sealed bag.

7. The device of claim 5, wherein the sealed solution container is a rigid plastic container, and wherein the second quick connector is mounted on the rigid plastic container.

8. The device of claim 5, wherein the spray nozzle comprises an electrostatic spray device.

9. The device of claim 5, wherein the spray nozzle comprises a turbulent flow spray device operable to spray a mist or fog of atomized spray.

10. The device of claim 5, wherein the first and second quick connectors comprise interlocking male and female connectors operable to create a watertight seal when the first and second quick connectors are interconnected.

11. A sprayer device comprising:
a pump having a pump inlet and a pump outlet, the pump inlet including a first quick connector;
a spray nozzle fluidly communicated with the pump outlet; and
a hermitically sealed solution container including a second quick connector, the second quick connector removably connectable to the first quick connector of the pump inlet to fluidly communicate the solution container with the pump inlet, the second quick connector including a valve biased in a closed position when the first and second quick connectors are not connected to one another, and the valve is moved to an open position when the first and second quick connectors are connected to one another.

12. A method of spraying a solution comprising the steps of:
providing a sprayer device including a pump having a pump inlet and a pump outlet, the pump inlet including a first quick connector and a spray nozzle fluidly communicated with the pump outlet;
providing a first sealed solution container prefilled with the solution, the first sealed solution container including a second quick connector;
removably connecting the first quick connector to the second quick connector to fluidly communicate the sealed solution container with the pump inlet; and
pumping the solution via the pump from the first sealed solution container to the spray nozzle.

13. The method of claim 12, further comprising the steps of:
positioning the pump inside of a pump housing; and
positioning the first sealed solution container inside of a container support structure such that the first sealed solution container is removable from the container support structure.

14. The method of claim 13, wherein the pump housing and the container support structure are both located inside of a backpack carrier.

15. The method of claim 14, further comprising the steps of:
disconnecting the first and second quick connectors from one another;
providing a second sealed solution container prefilled with a second solution, the second sealed solution container including a third quick connector;
connecting the first and third quick connectors to fluidly couple the second sealed solution container to the pump inlet; and
pumping the second solution via the pump from the second sealed solution container to the spray nozzle.

16. The method of claim 15, wherein the first and second sealed solution containers each comprise a hermitically sealed bag that includes a carrying handle;
wherein the third quick connector is bonded to the hermetically sealed bag of the second sealed solution container.

17. The method of claim 15, wherein the first and second sealed solution containers each comprise a rigid plastic container;
wherein each corresponding quick connector is mounted on the corresponding rigid plastic container.

18. The method of claim 15, wherein the spray nozzle is an electrostatic spray device.

19. The method of claim 15, wherein the spray nozzle is a turbulent flow spray device operable to spray a mist or fog of atomized spray.

20. The method of claim 15, further comprising the step of prefilling the sealed solution container with the solution via the second quick connector.
